(19) United States
(12) Patent Application Publication
(10) Pub. No.: US 2005/0247514 A1
(43) Pub. Date: Nov. 10, 2005

(54) Belt tightener for a steering booster

(75) Inventor: Dieter Heitzer, Heinsberg (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: TRW Automotive GmbH

(21) Appl. No.: 11/181,656

(22) Filed: Jul. 14, 2005

Related U.S. Application Data
(63) Continuation of application No. PCT/EP04/00233, filed on Jan. 14, 2004.

(30) Foreign Application Priority Data
Jan. 16, 2003 (DE) 203 00 674.7

(51) Int. Cl. B62D 5/04

(52) U.S. Cl. 180/444

(57) ABSTRACT

A power steering drive for a steering mechanism, including a motor having a drive shaft, and a belt drive by which the motor can drive the steering mechanism, the motor including a connecting element for installation on the belt drive, the connecting element having a rotation axis, wherein the drive shaft of the motor is parallel to and offset from the rotation axis.

The invention relates to a power steering drive for a steering mechanism, comprising a motor having a drive shaft, and a belt drive by which the motor can drive the steering mechanism, the motor including a connecting element for installation on the belt drive, the connecting element having a rotation axis.

Such a power steering drive is described for example in WO 01/15959 A1. This steering mechanism is equipped with an axially displaceable rack and receives steering power assistance by an electronically controlled electric motor, which acts on the rack via a belt drive. The belt drive has a housing to which the electric motor is flange-mounted, so that the drive shaft of the motor projects into the housing of the belt drive. Here, a belt pulley sits on the end of the drive shaft, into which belt pulley the belt of the belt drive is guided. For a secure and reliable operation of the power steering drive, it is desirable to be able to adjust the belt tension.

For this purpose, in a power steering drive of the type initially mentioned, provision is made that the drive shaft of the motor is parallel to and offset from the rotation axis thereof. Therefore, during installation, the motor can be rotated about the rotation axis of the connecting element, the drive shaft of the motor being swiveled and therefore altering its distance from the steering mechanism. In this way, in a simple manner, the belt tension van be varied and subsequently established by fixing the motor in the swiveled position which is reached.

Further embodiments and the advantages thereof will be apparent from the sub-claims.

The invention is described in further detail below with the aid of a preferred embodiment. Here, reference is made to the enclosed drawings, in which:

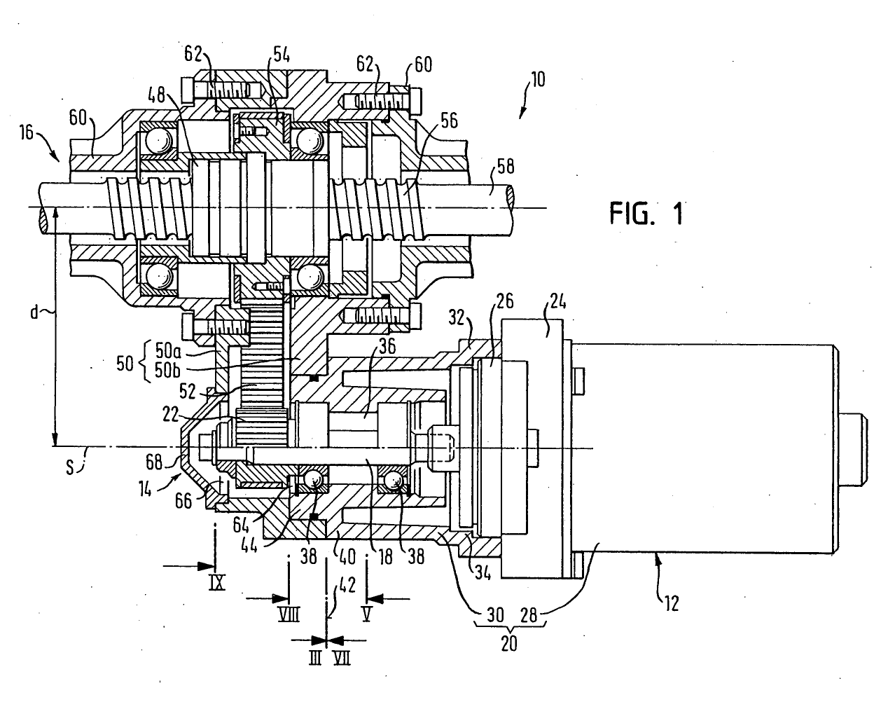

FIG. 1 shows a cross-section through a power steering drive and a part of a steering mechanism driven thereby;

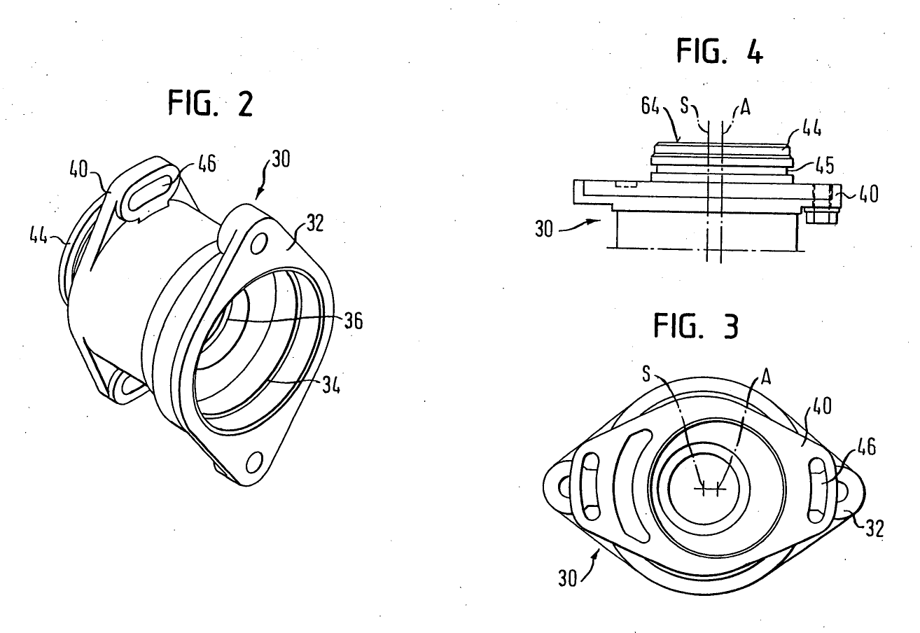

FIG. 2 shows a perspective view of a flanged sleeve of the power steering drive of FIG. 1;

FIG. 3 shows a view of the flanged sleeve of FIG. 2 in the direction marked by III in FIG. 1;

FIG. 4 shows a side view of a part of the flanged sleeve of FIG. 2;

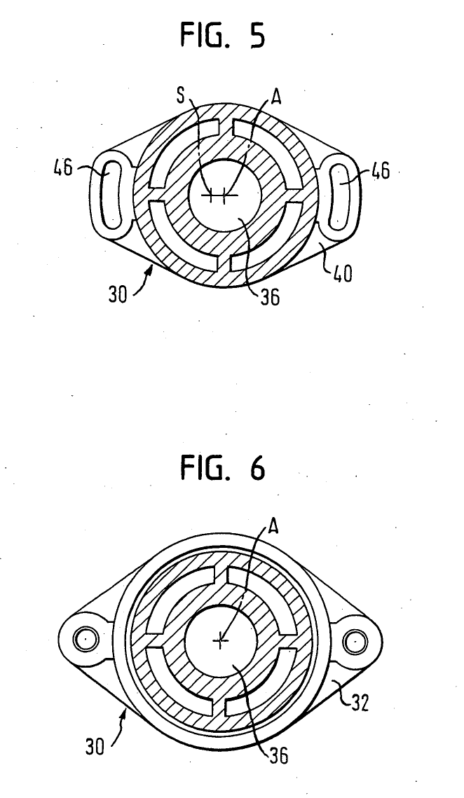

FIG. 5 shows a cross-section through the flanged sleeve of FIG. 2 along the line V in FIG. 1;

FIG. 6 shows a cross-section through the flanged sleeve of FIG. 2 along the line V in FIG. 1 in the opposite direction;

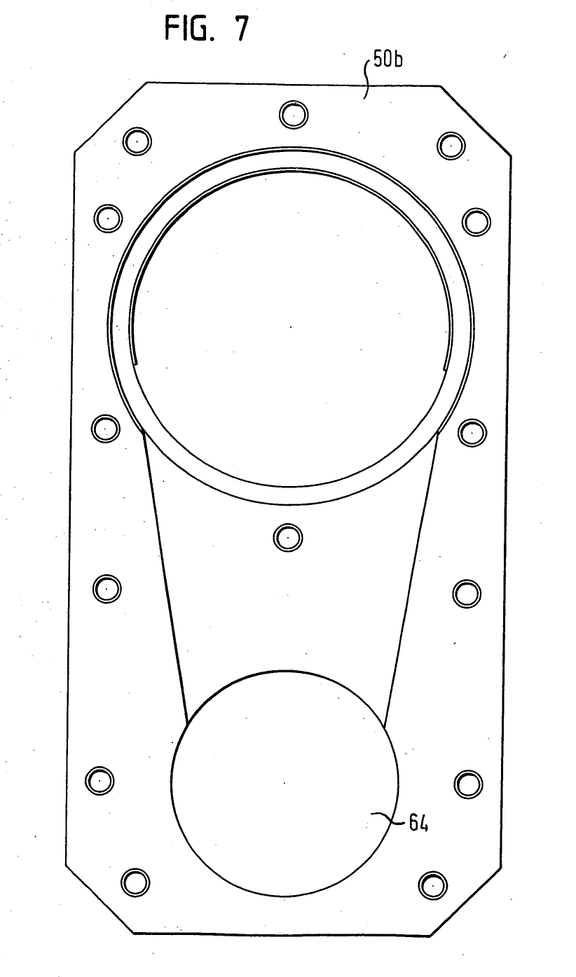

FIG. 7 shows a view of the housing of the power steering drive of FIG. 1 in the direction marked by VI in FIG. 1;

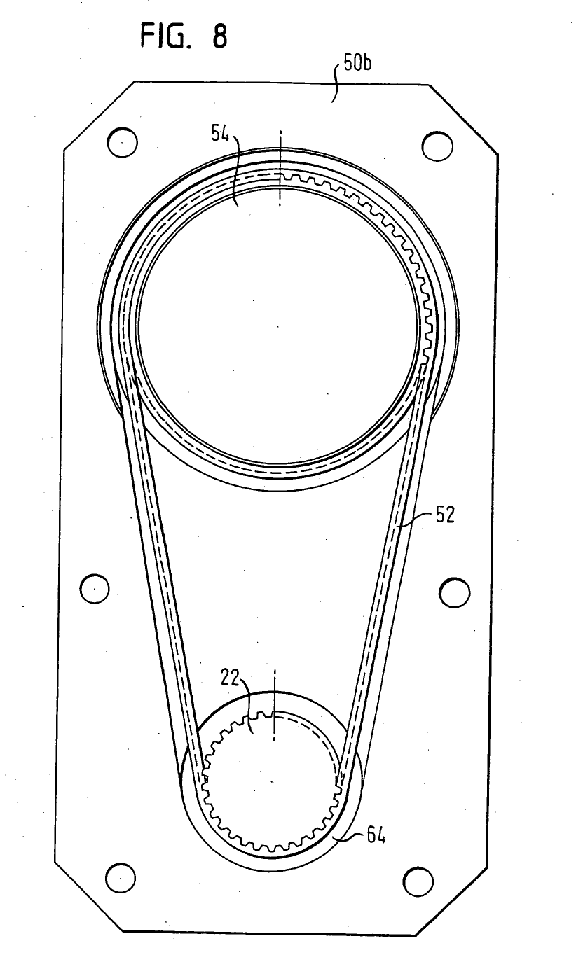

FIG. 8 shows a view of a housing part of the power steering drive of FIG. 1 in the direction marked by VIII in FIG. 1; and

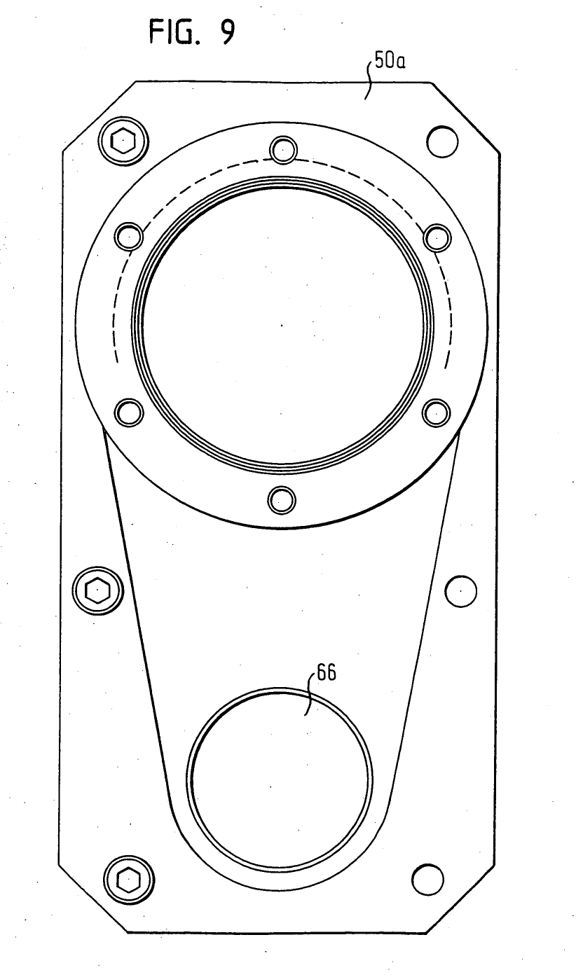

FIG. 9 shows a cross-section through the power steering drive of FIG. 1 in the direction marked by IX in FIG. 1.

In FIG. 1 a power steering drive 10 according to the invention is illustrated with a motor 12 and a belt drive 14 in cross-section. The power steering drive 10 serves for steering power assistance for a steering mechanism 16, which is illustrated only partially in FIG. 1, because the function of the steering mechanism per se is sufficiently known from the prior art.

In the illustrated embodiment, the motor 12 has an electric motor 26 with a drive shaft 18, which is housed in a motor housing 20. The drive shaft 18 projects out from the motor housing 20 and is provided at its free end with a small belt pulley 22. The motor housing 20 consists of a cylindrical cap 28 which is concentric with the drive shaft 18 and is provided on the output side with a housing flange 24, and of a flanged sleeve 30 which surrounds the end of the drive shaft 18 projecting out on the output side. Here, the flanged sleeve 30 extends so far that it leaves the small belt pulley 22 free. Facing the cap 28, the flanged sleeve 30 has a motor flange 32, by which it is fastened to the housing flange 24. Here, the motor flange 32 comprises a cup-shaped motor bearing 34 which is constructed in the flanged sleeve 30 and can receive the electric motor 26 with a precise fit. The flanged sleeve 30 is provided with a central through bore 36 for the drive shaft 18. Here, the drive shaft 18 is preferably mounted in the flanged sleeve 30 by means of two shaft bearings 38, which rest in the bore 36.

At its end on the output side, facing away from the cap 28, the flanged sleeve 30 is provided with an output flange 40 which defines a flange plane 42 perpendicular to the drive shaft 18. A rotationally symmetrical connecting element in the form of an annular collar 44 with a rotation axis A extends perpendicularly from the flange plane 42. The collar 44 is arranged such that the drive shaft 18 of the motor 12 is parallel to and offset from the rotation axis A. This means that the collar 44 is eccentric to the drive shaft 18. The collar 44 can preferably be provided with an encircling groove 45 to receive a seal. Further formed in the output flange 40 are curved elongated holes 46, which are arranged on circular arcs around the rotation axis A.

The belt drive 14 has a belt housing 50 which surrounds a drive belt 52 and consists of a first housing shell 50a and a second housing shell 50b. The drive belt 52 loops on the one hand around the small belt pulley 22 and on the other hand around a large belt pulley 54. The large belt pulley 54 is connected with a recirculating ball nut 48, which runs on a spindle section 56 of the rack 58 of the steering mechanism 16, only a section of the rack 58 being illustrated in FIG. 1. The recirculating ball nut 48 converts the rotary movement, transferred by the belt drive 14 from the motor 12, into an axial displacement of the rack 58, as is sufficiently known from the prior art. As is likewise indicated in FIG. 1, the rack 58 is surrounded on both sides of the belt housing 50 by protective sleeves 60 which are fastened to the belt housing 50, for example by means of screws 62.

In the region of the small belt pulley 22, the belt housing 50, more precisely the second housing shell Sob, is provided with a drive opening 64 in which the collar 44 is accommodated for rotation about the rotation axis A. The drive opening 64 is advantageously constructed so as to be cylindrical, its diameter being adapted such that the collar 44 is rotatable therein with a precise fit.

As a result of the eccentric arrangement of the collar 44 with respect to the drive shaft 18, the rotation axis A, the distance d between the drive shaft 18 and the axis of the rack 58 changes upon a rotation of the flanged sleeve 30 in the drive opening 64. In this way, by simply turning the flanged sleeve 30, the tension of the drive belt 52 can be adjusted advantageously during installation of the motor 12 on the belt housing 50. When the desired belt tension is reached, the rotary position of the flanged sleeve 30 can be fixed, by the latter for example being screwed by its output flange 40 to the belt housing 50. The elongated holes 46, constructed in a curved shape, in the output flange 40 advantageously make possible a fixing of the flanged sleeve 30 in a wide continuous adjustment range.

In the first housing shell 50a, opposite the drive opening 64 of the second housing shell 50b a maintenance opening 66 is formed, through which the free end of the drive shaft 18 is accessible. The maintenance opening 66 is closed by a covering cap 68.

Of course, other design forms are also conceivable for the connecting element and the drive opening 64, which permit a rotation of the motor 12 about the rotation axis A. For example, a polygonal drive opening in the belt housing or designing the connecting element as arc segments would be conceivable.

The invention therefore makes it possible to change over the belt tension in a simple manner during installation of the power steering drive. Therefore, for example, tolerances of the drive belts can be balanced out. The setting of a defined belt tension can ensure a maintenance-free and trouble-free operation of the power steering drive over the entire working life.

1. A power steering drive for a steering mechanism, comprising a motor having a drive shaft, and a belt drive by which the motor can drive the steering mechanism, the motor including a connecting element for installation on the belt drive, the connecting element having a rotation axis, characterized in that wherein the drive shaft of the motor is parallel to and offset from the rotation axis.

2. The power steering drive according to claim 1, wherein the connecting element is constructed as an annular collar which is accommodated in a recess on the belt drive for rotation about the rotation axis.

3. The power steering drive according to claim 1, wherein the connecting element is constructed on a flanged sleeve which has a flange for fastening to the belt drive.

4. The power steering drive according to claim 3, wherein the flange has curved elongated holes with respect to the rotation axis.

5. The power steering drive according to claim 3 wherein the flanged sleeve is detachably fastened to the motor.

6. The power steering drive according to claim 1, wherein the connecting element is constructed as an annular collar which is accommodated in a recess on the belt drive for rotation about the rotation axis, and wherein the connecting element is constructed on a flanged sleeve which has a flange for fastening to the belt drive.

7. The power steering drive according to claim 3, wherein the flange has curved elongated holes with respect to the rotation axis, and wherein the flanged sleeve is detachably fastened to the motor.
